(19) United States
(12) Patent Application Publication
(10) Pub. No.: US 2025/0256498 A1
(43) Pub. Date: Aug. 14, 2025

(54) SUPPORT COMPONENT AND LAMINATION DEVICE

(71) Applicant: Yungu (Gu'an) Technology Co., Ltd., Langfang (CN)

(72) Inventors: Zeming YANG, Langfang (CN); Zhipeng XU, Langfang (CN); Yuanyuan CHEN, Langfang (CN); Liubin FAN, Langfang (CN); Mingxing LIU, Langfang (CN); Jingjing ZHAO, Langfang (CN)

(73) Assignee: Yungu (Gu'an) Technology Co., Ltd., Langfang (CN)

(21) Appl. No.: 19/193,927

(22) Filed: Apr. 29, 2025

Related U.S. Application Data
(63) Continuation of application No. PCT/CN2023/090843, filed on Apr. 26, 2023.

(30) Foreign Application Priority Data
Nov. 24, 2022 (CN) 202211480202.1

(51) Int. Cl. B32B 37/00; B32B 37/10

(52) U.S. Cl. CPC B32B 37/0046; B32B 37/10; B32B 2457/20

(57) ABSTRACT

The embodiments of the present application provide a support component and a lamination device. The support component is configured to laminate a curved cover plate with a flexible screen, and the support component includes: a base; and a flexible support table arranged on the base and configured to support the flexible screen. The flexible support table includes a main body portion and an arc-shaped portion arranged on at least one side of the main body portion. The arc-shaped portion has an arc-shaped support surface configured to support the flexible screen, and an abutting surface facing the base. The abutting surface is provided with a recessed portion.

### CROSS-REFERENCE TO RELATED APPLICATIONS

The present application a continuation of International Application No. PCT/CN2023/090843 filed on Apr. 26, 2023, which claims priority to Chinese Patent Application No. 202211480202.1, filed on Nov. 24, 2022. All of the aforementioned patent applications are hereby incorporated by reference in their entireties.

### TECHNICAL FIELD

The present application relates to the technical field of flexible screen lamination equipment, and in particular to a support component and a lamination device.

### BACKGROUND

With the advent of the ubiquitous screen era, people's demand for full screens is becoming stronger and stronger. In order to increase the screen-to-body ratio, dual-curved lamination technology and quad-curved lamination technology have emerged.

In the prior art, the flexible characteristics of the flexible screen are mainly used to achieve a full screen. At present, the lamination methods for the flexible screen are mainly to use a silicone pad to press the flexible screen to an inner side of a glass curved cover plate. During lamination, the silicone pad is deformed due to the pressures from upper and lower jigs, to complete the lamination of the flexible screen with the curved cover plate. When the silicone pad is not deformed enough, it is possible to cause bubbles between the flexible screen and the curved cover plate.

### SUMMARY

Embodiments of the present application provide a support component and a lamination device, which are intended to solve the problem of the generation of bubbles during lamination of a flexible screen with a curved cover plate.

In a first aspect, the embodiments of the present application provide a support component for laminating a curved cover plate with a flexible screen, the support component including: a base; and a flexible support table arranged on the base and configured to support the flexible screen. The flexible support table includes a main body portion and an arc-shaped portion arranged on at least one side of the main body portion. The arc-shaped portion has an arc-shaped support surface configured to support the flexible screen, and an abutting surface facing the base. The abutting surface is provided with a recessed portion.

In a second aspect, the embodiments of the present application further provide a lamination device for laminating a curved cover plate with a flexible screen, the lamination device including a support component according to any of the above embodiments of the first aspect, and a pressing table, the pressing table being arranged on one side of the support component, the pressing table having a receiving recess for receiving the curved cover plate, and an opening of the receiving recess facing the support component.

In the support component provided in the embodiments of the present application, the support component is configured to laminate the curved cover plate with the flexible screen, the base of the support component is configured to provide a support force, and the flexible support table of the support component is configured to support the flexible screen. The curved cover plate and the flexible screen are laminated with each other by means of the deformation of the flexible support table. The flexible support table includes the main body portion configured to support the flexible screen to laminate with a flattened portion of the curved cover plate, and the arc-shaped portion configured to support the flexible screen to laminate with a specially-shaped portion of the curved cover plate. The arc-shaped portion has an arc-shaped support surface configured to support the flexible screen, such that the flexible screen can be better laminated with the specially-shaped portion of the curved cover plate. By providing the recessed portion on the abutting surface of the arc-shaped portion facing the base, the recessed portion can improve the deformation capability of the arc-shaped portion, so that the flexible screen arranged on the arc-shaped support surface can be better laminated with the curved cover plate, thereby effectively alleviating the problem of the generation of bubbles during the lamination of the flexible screen with the curved cover plate. Moreover, the recessed portion can also reduce the force exerted by the arc-shaped portion on the flexible screen, and thus reduce the force exerted by the flexible screen on the specially-shaped portion of the curved cover plate, thereby alleviating the problem of the specially-shaped portion of the curved cover plate being prone to crack. Therefore, in the embodiments of the present application, by providing the recessed portion on the abutting surface of the arc-shaped portion facing the base, not only can the problem of the generation of bubbles during the lamination of the flexible screen with the curved cover plate be effectively alleviated, but the problem of the specially-shaped portion of the curved cover plate being prone to crack during the lamination can also be effectively alleviated.

### BRIEF DESCRIPTION OF THE DRAWINGS

FIG. 1 is a structural schematic view of a display device according to an embodiment of the present application;

FIG. 2 is a structural schematic view of a support component in use according to an embodiment of a first aspect of the present application;

FIG. 3 is a structural schematic perspective view of a flexible support table of a support component according to an embodiment of the first aspect of the present application;

FIG. 4 is a structural schematic partial enlarged view of a flexible support table of a support component according to an embodiment of the present application;

FIG. 5 is a bottom view of a flexible support table of a support component according to an embodiment of the present application;

FIG. 6 is a structural schematic view of a support component according to another embodiment of the present application;

FIG. 7 is a structural schematic perspective view of a flexible support table of a support component according to another embodiment of the present application;

FIG. 8 is a bottom view of a flexible support table of a support component according to another embodiment of the present application;

FIG. 9 is a bottom view of a flexible support table of a support component according to still another embodiment of the present application;

FIG. 10 is a bottom view of a flexible support table of a support component according to still another embodiment of the present application;

FIG. 11 is a bottom view of a flexible support table of a support component according to still another embodiment of the present application;

FIG. 12 is a structural schematic view of a flexible support table of a support component according to an embodiment of the present application;

FIG. 13 is a structural schematic view of a flexible support table of a support component according to yet another embodiment of the present application;

FIG. 14 is a structural schematic view of a flexible support table of a support component according to a further embodiment of the present application;

FIG. 15 is a structural schematic partial enlarged view of FIG. 14;

FIG. 16 is a structural schematic view of a base of a support component according to an embodiment of the present application;

FIG. 17 is a structural schematic view of a support component according to a till further embodiment of the present application;

FIG. 18 is a structural schematic view of a support component according to a yet further embodiment of the present application; and

FIG. 19 is a structural schematic view of a lamination device according to an embodiment of the present application.

### DETAILED DESCRIPTION OF THE EMBODIMENTS

As shown in FIG. 1, FIG. 1 shows a structural schematic exploded view of a display device including a flexible screen 20 and a curved cover plate 10 which are laminated with each other. The curved cover plate 10 includes a flattened portion 12 and a specially-shaped portion 11 located on at least one side in a circumferential direction of the flattened portion 12. The specially-shaped portion 11 is bent with respect to the flattened portion 12, and the flexible screen 20 is laminated with the flattened portion 12 and the specially-shaped portion 11 so that the specially-shaped portion 11 is also available for display, thereby increasing the screen-to-body ratio of the display device.

During the lamination of the flexible screen 20 with the curved cover plate 10, the flexible screen 20 is generally arranged on a deformable flexible support table, such that the flexible screen 20 can be better laminated with the specially-shaped portion 11 of the curved cover plate 10 by means of the deformation of the flexible support table. There is a problem in the related art of the presence of bubbles between the flexible screen 20 and the curved cover plate 10 caused by insufficient deformation of the flexible support table.

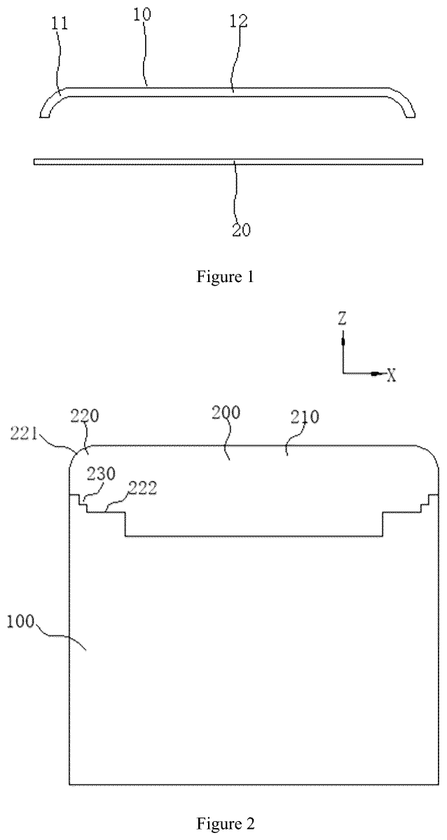

In order to solve the above technical problem, the present application is provided. In order to better understand the present application, a support component and a lamination device according to the embodiments of the present application will be described in detail below with reference to FIGS. 2 to 19.

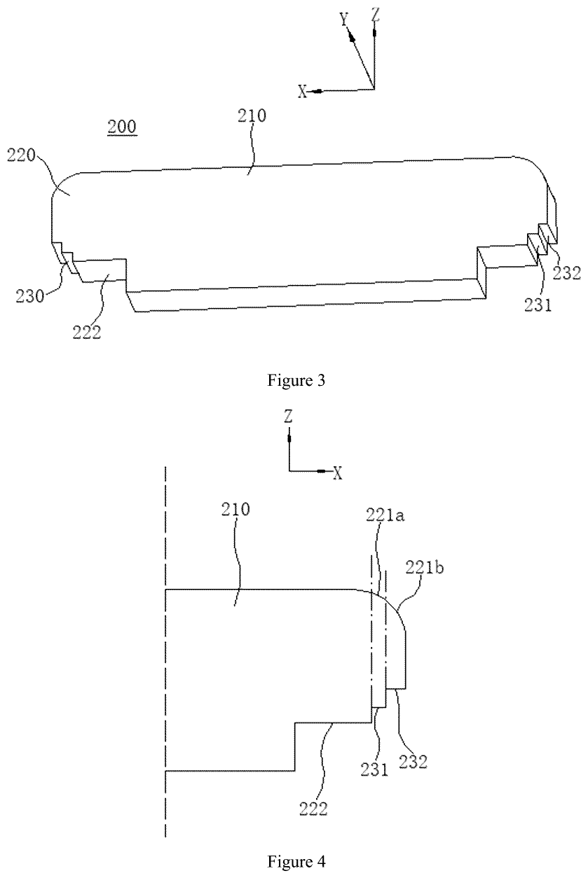

Referring to FIGS. 2 and 3 together, FIG. 2 is a structural schematic view of a support component in use according to an embodiment of a first aspect of the present application, and FIG. 3 is a structural schematic perspective view of a flexible support table 200 of a support component according to an embodiment of the first aspect of the present application.

As shown in FIGS. 2 and 3, the embodiments of the first aspect of the present application provide a support component for laminating a curved cover plate 10 with a flexible screen 20 as shown in FIG. 1. The support component includes a base 100 and a flexible support table 200. The flexible support table 200 is arranged on one side of the base 100 in a first direction Z and configured to support the flexible screen 20. The flexible support table 200 includes a main body portion 210 and an arc-shaped portion 220 arranged on at least one side of the main body portion 210. The arc-shaped portion 220 has an arc-shaped support surface 221 configured to support the flexible screen 20, and an abutting surface 222 facing the base 100. The abutting surface 222 is provided with a recessed portion 230.

The base 100 may be configured in a variety of ways. In one embodiment, the base 100 may be formed from a rigid material such as metal and plastic, such that the base 100 can provide good support for the flexible support table 200.

The flexible support table 200 may be configured in a variety of ways. In one embodiment, the flexible support table 200 may be formed from a flexible material such as silicone, such that the flexible support table 200 has a good deformation capability. The flexible support table 200 may alternatively be formed from another elastic material with deformation capability, as long as the flexible support table 200 has a certain flexibility such that the arc-shaped support surface 221 can be deformed. A surface of the main body portion 210 that supports the flexible screen 20 may be shaped as a planar or specially-shaped surface.

In one embodiment, the arc-shaped support surface 221 is adapted to the shape of a specially-shaped portion 11.

In the support component provided in the embodiments of the present application, the support component is configured to laminate the curved cover plate 10 with the flexible screen 20, the base 100 of the support component is configured to provide a support force, and the flexible support table 200 of the support component is configured to support the flexible screen 20. The curved cover plate 10 and the flexible screen 20 are laminated with each other by means of the deformation of the flexible support table 200. The flexible support table 200 includes the main body portion 210 and the arc-shaped portion 220. The main body portion 210 is configured to support the flexible screen 20 to laminate with a flattened portion 12 of the curved cover plate 10, and the arc-shaped portion 220 is configured to support the flexible screen 20 to laminate with the specially-shaped portion 11 of the curved cover plate 10. The arc-shaped portion 220 has an arc-shaped support surface 221 configured to support the flexible screen 20, such that the flexible screen 20 can be better laminated with the specially-shaped portion 11 of the curved cover plate 10. By providing the recessed portion 230 on the abutting surface 222 of the arc-shaped portion 220 facing the base 100, the recessed portion 230 can improve the deformation capability of the arc-shaped portion 220, so that the flexible screen 20 arranged on the arc-shaped support surface 221 can be better laminated with the curved cover plate 10, thereby effectively alleviating the problem of the generation of bubbles during the lamination of the flexible screen 20 with the curved cover plate 10. Moreover, the recessed portion 230 can also reduce the force exerted by the arc-shaped portion 220 on the flexible screen 20, and thus reduce the force exerted by the flexible screen 20 on the specially-shaped portion 11 of the curved cover plate 10, thereby alleviating the problem of the specially-shaped portion 11 of the curved cover plate 10 being prone to crack. Therefore, in the embodiments of the present application, by providing the recessed portion 230 on the abutting surface 222 of the arc-shaped portion 220 facing the base 100, not only can the problem of the generation of bubbles during the lamination of the flexible screen 20 with the curved cover plate 10 be effectively alleviated, but the problem of the specially-shaped portion 11 of the curved cover plate 10 being prone to crack during the lamination can also be effectively alleviated.

The recessed portion 230 may be configured in a variety of ways. For example, the recessed portion 230 includes a groove and/or a stepped groove formed by recessing at least part of the abutting surface 222. The groove and/or the stepped groove may be configured to be disconnected from or connected to an edge of the abutting surface 222 facing away from the main body portion 210.

In some embodiments, still referring to FIG. 3, the recessed portion 230 includes a first step surface 231 and a second step surface 232 arranged in a direction away from the main body portion 210 and located on a side of the abutting surface 222 facing the arc-shaped support surface 221, and a distance between the first step surface 231 and the abutting surface 222 is smaller than a distance between the second step surface 232 and the abutting surface 222 in the first direction Z.

In these embodiments, the recessed portion 230 includes the first step surface 231 and the second step surface 232, and the distance between the first step surface 231 and the abutting surface 222 is smaller than the distance between the second step surface 232 and the abutting surface 222, that is, the recessed portion 230 is in the form of a step, so that the arc-shaped portion 220 has different thicknesses at different positions away from the main body portion 210, further improving the deformation capability of the arc-shaped portion 220 at different locations, and better alleviating the problem of bubbles being likely to be generated between the flexible screen 20 and the curved cover plate 10.

In one embodiment, the recessed portion 230 further includes a first connecting surface (not shown) connecting the first step surface 231 and the second step surface 232. In one embodiment, the first connecting surface is formed by extending in the first direction Z to facilitate the preparation and shaping of the recessed portion 230.

In one embodiment, the recessed portion 230 may also include a further step surface, which is located on a side of the first step surface 231 facing away from the second step surface 232, or on a side of the second step surface 232 facing away from the first step surface 231. In one embodiment, when the distance between the further step surface and the abutting surface 222 is smaller than the distance between the first step surface 231 and the abutting surface 222, the further step surface is located on the side of the first step surface 231 facing away from the second step surface 232, and when the distance between the further step surface and the abutting surface 222 is greater than the distance between the second step surface 232 and the abutting surface 222, the further step surface is located on the side of the second step surface 232 facing away from the first step surface 231, so that the recessed portion 230 is generally in the form of a step and the thickness of the arc-shaped portion 220 decreases in a gradient manner.

In some embodiments, the first step surface 231 is located on a side of the second step surface 232 close to the main body portion 210 in a direction perpendicular to the first direction.

In these embodiments, since the first step surface 231 is closer to the main body portion 210, the depth of the recessed portion 230 relative to the abutting surface 222 gradually increases in a direction from the main body portion 210 to the arc-shaped portion 220, the thickness of the arc-shaped portion 220 gradually decreases, and the bending deformation capability of the arc-shaped portion 220 gradually increases, so that as the flexible screen 20 is gradually laminated with the curved cover plate 10 from the middle to two sides, the flexible screen 20 can be better laminated with parts of specially-shaped portions 11 on the two sides, thereby better alleviating the problem of bubbles being likely to be generated between an edge part of the curved cover plate 10 and the flexible screen 20.

Referring to FIGS. 2 to 4 together, FIG. 4 is a structural schematic partial enlarged view of a flexible support table 200 of a support component according to an embodiment of the present application.

In some embodiments, as shown in FIGS. 2 to 4, the first step surface 231 and the second step surface 232 are both laminated with the base 100, and part of the arc-shaped support surface 221 that overlaps the first step surface 231 has a greater curvature than part of the arc-shaped support surface 221 that overlaps the second step surface 232 in the first direction Z.

For example, as shown in FIG. 4, the arc-shaped support surface 221 includes a first arc-shaped surface 221a and a second arc-shaped surface 221b. The first arc-shaped surface 221a overlaps the first step surface 231 in the first direction Z. That is, an orthographic projection of the first arc-shaped surface 221a in the first direction Z overlaps an orthographic projection of the first step surface 231 in the first direction Z. The second arc-shaped surface 221b overlaps the second step surface 232 in the first direction Z. That is, an orthographic projection of the second arc-shaped surface 221b in the first direction Z overlaps an orthographic projection of the second step surface 232 in the first direction Z. The curvature of the first arc-shaped surface 221a is greater than the curvature of the second arc-shaped surface 221b. That is, the first arc-shaped surface 221a is curved to a greater degree than the second arc-shaped surface 221b.

In these embodiments, since the first step surface 231 and the second step surface 232 are both laminated with the base 100, part of the arc-shaped portion 220 corresponding to the first step surface 231 has a greater thickness and part of the arc-shaped portion 220 corresponding to the second step surface 232 has a smaller thickness, then the amount of elastic deformation of the part of the arc-shaped portion 220 itself corresponding to the first step surface 231 is greater than the amount of elastic deformation of the part of the arc-shaped portion 220 corresponding to the second step surface 232, and the first arc-shaped surface 221a corresponding to the first step surface 231 can have a greater deformation, and can better adapt to the specially-shaped portion 11 with a greater curvature, thereby better alleviating the problem of lamination bubbles being likely to be generated between the flexible screen 20 and the specially-shaped portion 11.

In some embodiments, still referring to FIGS. 2 to 4, the first step surface 231 or the second step surface 232 is connected to the edge of the arc-shaped support surface 221 facing away from the main body portion 210, to facilitate the preparation and shaping of the recessed portion 230 in the form of a step.

For example, when the first step surface 231 and the second step surface 232 are laminated with the base 100, the second step surface 232 is connected to the edge of the arc-shaped support surface 221 facing away from the main body portion 210. During the initial stage of bending of the specially-shaped portion 11 relative to the main body portion 210, the curvature of the specially-shaped portion 11 is relatively large, and at the end of the specially-shaped portion 11 away from the main body portion 210, the curvature of the specially-shaped portion 11 is generally relatively small. The second step surface 232 is connected to the edge of the arc-shaped support surface 221 facing away from the main body portion 210, such that the shape of the arc-shaped portion 220 is adapted to the shape of the specially-shaped portion 11, thereby better alleviating the problem of lamination bubbles being likely to be generated between the specially-shaped portion 11 and the flexible screen 20.

In some other embodiments, it is also possible that the first step surface 231 is connected to the edge of the arc-shaped support surface 221 facing away from the main body portion 210.

In the curved cover plate 10, there may be two specially-shaped portions 11 respectively arranged on two sides of the main body portion 210. That is, the curved cover plate 10 is a dual-curved cover plate. Alternatively, the curved cover plate 10 may be a quad-curved cover plate, there are four specially-shaped portions 11 respectively arranged on peripheral sides of the main body portion 210, and an arc-shaped connecting portion may also be connected between two adjacent specially-shaped portions 11.

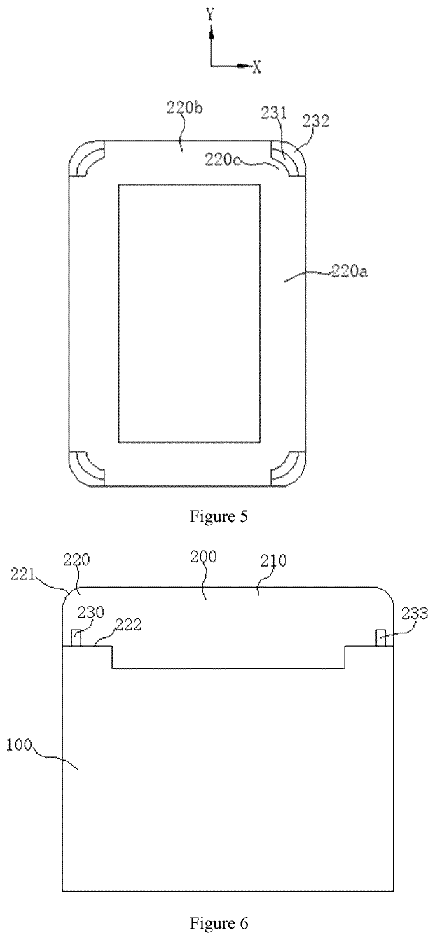

Referring to FIGS. 3 to 5 together, FIG. 5 is a bottom view of a flexible support table 200 of a support component according to an embodiment of the present application.

In the support component according to some embodiments of the present application, as shown in FIGS. 3 to 5, the arc-shaped portion 220 includes a first arc-shaped portion 220a located on at least one side of the main body portion 210 in a second direction X, a second arc-shaped portion 220b located on at least one side of the main body portion 210 in a third direction Y, and a bent portion 220c connecting the first arc-shaped portion 220a and the second arc-shaped portion 220b. The bent portion 220c is provided with the first step surface 231 and the second step surface 232.

In these embodiments, the bent portion 220c is more complex in shape relative to the first arc-shaped portions 220a and the second arc-shaped portion 220b, and it is more likely to generate bubbles when the flexible screen 20 supported by the bent portion 220c is laminated with the curved cover plate 10. The arrangement of the first step surface 231 and the second step surface 232 at the bent portion 220c can better alleviate the problem of lamination bubbles being likely to be generated between the flexible screen 20 and the curved cover plate 10.

In other embodiments, it is also possible that the first arc-shaped portion 220a and/or the second arc-shaped portion 220b is provided with the first step surface 231 and the second step surface 232, as long as the arc-shaped portion 220 is provided with the first step surface 231 and the second step surface 232.

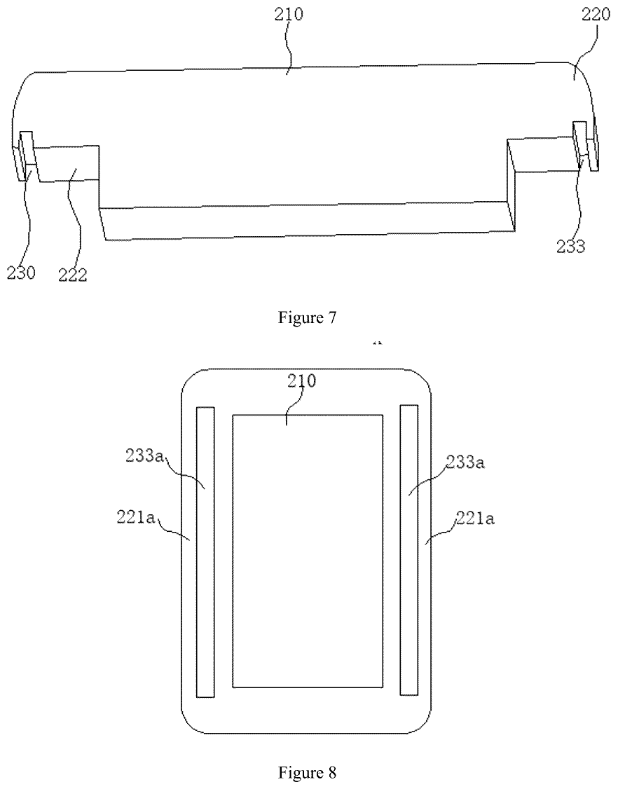

Referring to FIGS. 6 and 7 together, FIG. 6 is a structural schematic view of a support component according to another embodiment of the present application, and FIG. 7 is a structural schematic perspective view of a flexible support table 200 of a support component according to another embodiment of the present application.

In some embodiments, as shown in FIGS. 6 and 7, the recessed portion 230 further includes a groove 233 having an opening provided in the abutting surface 222. By providing the groove 233, it is possible to reduce the thickness of the arc-shaped portion 220 at the position where the groove 233 is located, to increase the bending deformation capability of the arc-shaped portion 220, to reduce the force exerted by the arc-shaped portion 220 on the flexible screen 20 during the lamination, and thus to reduce the force exerted by the flexible screen 20 on the specially-shaped portion 11 of the curved cover plate 10, thereby alleviating the problem of the curved cover plate 10 being prone to crack during the lamination.

In one embodiment, the groove 233 and an edge of the arc-shaped portion 220 facing away from the main body portion 210 are spaced apart from each other. As described above, the specially-shaped portion 11 in the initial stage of bending with respect to the flattened portion 12 has a relatively large curvature, and is prone to crack during the lamination. By making the groove 233 and the edge of the arc-shaped portion 220 facing away from the main body portion 210 spaced apart from each other, the groove 233 is closer to the position where the specially-shaped portion 11 is prone to crack, thereby better alleviating the problem of the curved cover plate 10 being prone to crack during the lamination.

In one embodiment, the depth of the groove 233 is greater than or equal to 1.5 mm, alleviating the problem of the curved cover plate 10 being prone to crack due to insufficient depth of the groove 233 resulting in insufficient bending deformation force of the arc-shaped portion 220 and excessive force provided by the arc-shaped portion 220 to the flexible screen 20.

In one embodiment, a surface of the base 100 that is configured to support the arc-shaped portion 220 may be in the form of a flat surface such that a bottom wall surface of the groove 233 is spaced apart from the base 100 to increase the bending deformation capability of the arc-shaped portion 220 at the position where the groove 233 is located. Alternatively, the base 100 may further include a protrusion located at the groove 233, so that the support force of the base 100 can be increased to better alleviate the problem of lamination bubbles.

Referring to FIGS. 5 to 8 together, FIG. 8 is a bottom view of a flexible support table 200 of a support component according to another embodiment of the present application.

As shown in FIGS. 5 to 8, the arc-shaped portion 220 includes a first arc-shaped portion 220a located on at least one side of the main body portion 210 in the second direction X. In one embodiment, the groove 233 includes a first groove 233a provided at the first arc-shaped portion 220a. The first groove 233a can reduce the thickness of the first arc-shaped portion 220a at its position, to increase the bending deformation capability of the first arc-shaped portion 220a and reduce the force exerted by the first arc-shaped portion 220a on the flexible screen 20, thereby alleviating the problem of the curved cover plate 10 being prone to crack during the lamination.

In one embodiment, the first groove 233a extends in the form of a strip in the third direction Y, so that the shape of the first groove 233a is more adapted to the shape of the first arc-shaped portion 220a, thereby better alleviating the problem of the curved cover plate 10 being prone to crack during the lamination.

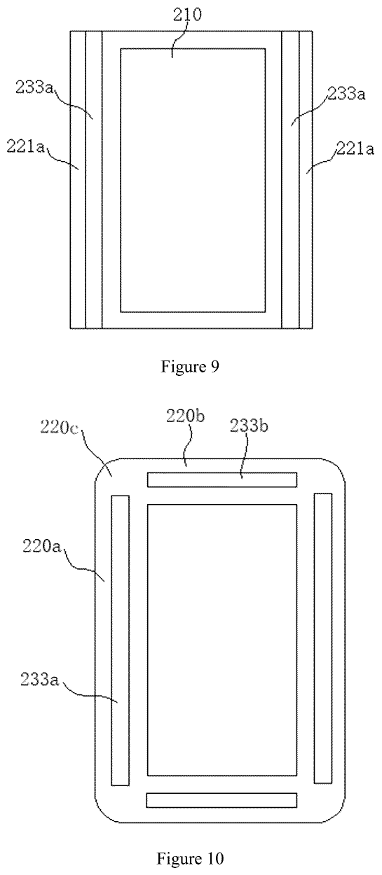

In one embodiment, as shown in FIG. 8, an extension length of the first groove 233a in the third direction Y may be smaller than an extension length of the first arc-shaped portion 220a in the third direction Y. Alternatively, as shown in FIG. 9, the extension length of the first groove 233a in the third direction Y may be equal to the extension length of the first arc-shaped portion 220a in the third direction Y. That is, it is also possible that the first groove 233a runs through the first arc-shaped portion 220a in the third direction Y. In one embodiment, when the extension length of the first groove 233a in the third direction Y is equal to the extension length of the first arc-shaped portion 220a in the third direction Y, the arc-shaped portion 220 is a hyperbolic arc-shaped portion, and the two first arc-shaped portions 220a are respectively arranged on two sides of the main body portion 210.

Referring to FIGS. 6, 7 and 10, FIG. 10 is a bottom view of a flexible support table 200 of a support component according to still another embodiment of the present application.

In some embodiments, as shown in FIGS. 6, 7 and 10, the arc-shaped portion 220 further includes a second arc-shaped portion 220b, and the groove 233 further includes a second groove 233b provided at the second arc-shaped portion 220b. By providing the second groove 233b, it is possible to reduce the thickness of the second arc-shaped portion 220b at the position where the second groove 233b is located, to increase the bending deformation capability of the second arc-shaped portion 220b, to reduce the force exerted by the arc-shaped portion 220 on the flexible screen 20 during the laminations, and thus to reduce the force exerted by the flexible screen 20 on the specially-shaped portion 11 of the curved cover plate 10, thereby alleviating the problem of the curved cover plate 10 being prone to crack during the lamination.

In one embodiment, the second groove 233b extends in the form of a strip in the second direction X, so that the shape of the second groove 233b is more adapted to the shape of the second arc-shaped portion 220b, thereby better alleviating the problem of the curved cover plate 10 being prone to crack during the lamination.

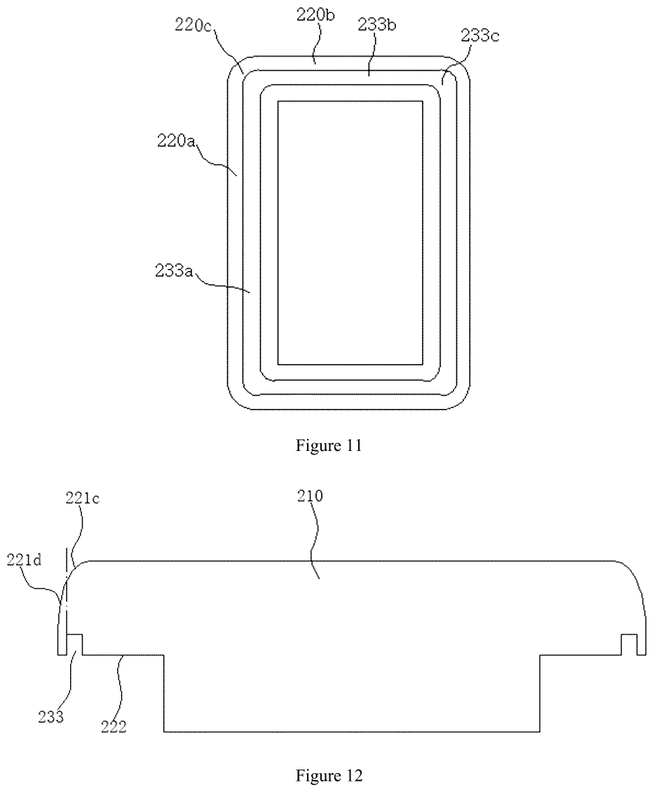

In one embodiment, the arc-shaped portion 220 further includes a bent portion 220c connecting the first arc-shaped portion 220a and the second arc-shaped portion 220b. As shown in FIG. 10, the first groove 233a and the second groove 233b may provide clearance for the bent portion 220c. Alternatively, as shown in FIG. 11, the groove further includes a third groove 233c. The third groove 233c is located at the bent portion 220c and connects the first groove 233a and the second groove 233b.

Referring to FIGS. 6 and 12 together, FIG. 12 is a structural schematic view of a flexible support table 200 of a support component according to an embodiment of the present application.

In some embodiments, as shown in FIGS. 6 and 12, the arc-shaped support surface 221 includes a first support surface 221c and a second support surface 221d arranged side by side in a direction away from the main body portion 210, the first support surface 221c having a greater curvature than the second support surface 221d, and the groove 233 and the first support surface 221c are arranged to at least partially overlap each other in the first direction Z of the flexible support table 200.

In these embodiments, the curvature of the first support surface 221c is relatively large, and the degree of bending of the first support surface 221c is thus relatively large, so that the curved cover plate 10 is more prone to crack at a position corresponding to the first support surface 221c; and the groove 233 and the first support surface 221c are arranged to at least partially overlap each other in the first direction Z such that at least part of the groove 233 can be arranged to correspond to the first support surface 221c, thereby increasing the bending deformation capability of the arc-shaped portion 220 at the position where the first support surface 221c is located, and better alleviating the problem of the curved cover plate 10 being prone to crack during the lamination.

The groove 233 and the first support surface 221c at least partially overlapping each other in the first direction Z means that the orthographic projection of the groove 233 in the first direction Z at least partially overlaps the orthographic projection of the first support surface 221c in the thickness direction.

In one embodiment, the projection of the first support surface 221c is located within the orthographic projection of the groove 233 in the first direction Z, so that the entire first support surface 221c is provided with the groove 233, thereby better alleviating the problem of the curved cover plate 10 being prone to crack during the lamination.

In one embodiment, an extension width of the groove 233 is greater than an extension width of the first support surface 221c. The width of the groove 233 is the extent of the groove 233 in the direction from the main body portion 210 to the arc-shaped portion 220. For example, when the groove 233 is the first groove 233a, the width of the groove 233 is the extent of the groove 233 in the second direction X. When the groove 233 is the second groove 233b, the width of the groove 233 is the extent of the groove 233 in the third direction Y.

In these embodiments, the width of the groove 233 is relatively large and the groove 233 can cover the entire first support surface 221c, so that the problem of the curved cover plate 10 being prone to crack during the lamination can be better alleviated.

In any of the above embodiments, the recessed portion 230 may include only the first step surface 231 and the second step surface 232, and the first step surface 231 and the second step surface 232 may be located at any position of the arc-shaped portion 220. When the curved cover plate 10 is a quad-curved cover plate and the arc-shaped portion 220 includes a bent portion 220c, In one embodiment, the first step surface 231 and the second step surface 232 are located at the bent portion 220c of the arc-shaped portion 220 to better alleviate the problem of lamination bubbles.

It is also possible that the recessed portion 230 includes only the groove 233, and the groove 233 may be located at any position of the arc-shaped portion 220. When the curved cover plate 10 is a dual-curved or quad-curved cover plate, the groove 233 may extend in the form of a strip and is adapted to the shape of the arc-shaped portion 220.

In still some embodiments, the recessed portion 230 may include the first step surface 231 and the second step surface 232, and also the groove 233, and there are many ways to arrange the relative positions of the first step surface 231, the second step surface 232 and the groove 233. For example, when the curved cover plate 10 is a dual-curved cover plate, the first step surface 231 and the second step surface 232, and the groove 233 may be located on the same side or on different sides of the main body portion 210.

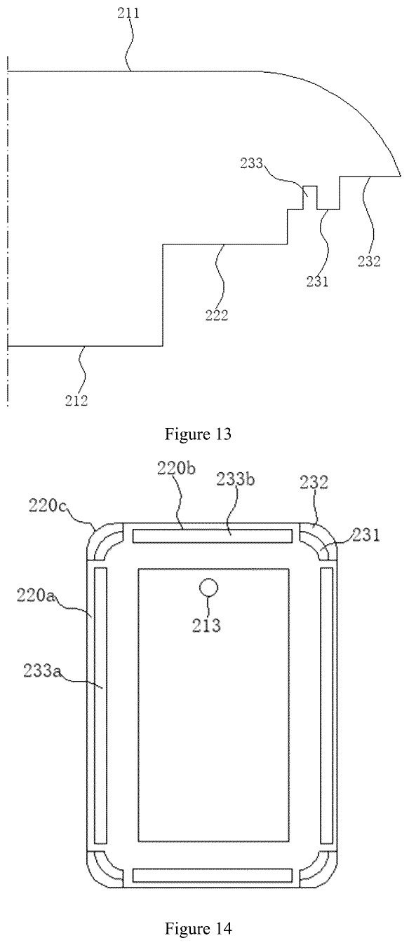

In one embodiment, as shown in FIG. 13, the groove 233 may be provided at the step surface to better adjust the deformation capability of the arc-shaped portion 220.

Alternatively, as shown in FIG. 14, when the curved cover plate 10 is a quad-curved cover plate, and the arc-shaped portion 220 includes a first arc-shaped portion 220a, a second arc-shaped portion 220b and a bent portion 220c, the first step surface 231 and the second step surface 232 are located on the bent portion 220c, and the groove 233 includes a first groove 233a located at the first arc-shaped portion 220a and a second groove 233b located at the second arc-shaped portion 220b. It is possible to alleviate both the problem of lamination bubbles and the problem of the curved cover plate 10 being prone to crack during the lamination.

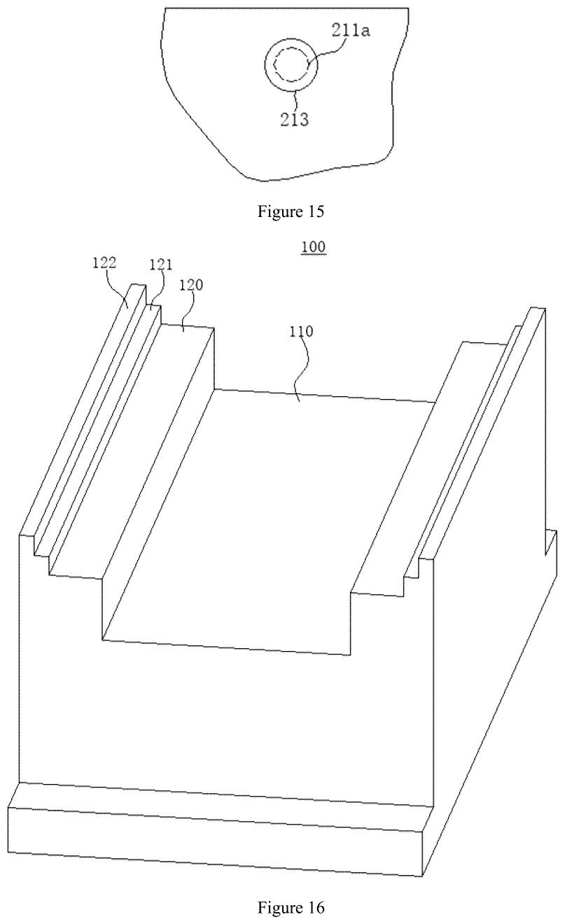

Referring to FIGS. 13 to 15 together, FIG. 15 is a structural schematic partial enlarged view of FIG. 14.

In some embodiments, as shown in FIGS. 13 to 15, the main body portion 210 includes a planar support surface 211 configured to support the flexible screen 20 and a support back surface 212 facing away from the planar support surface 211. The planar support surface 211 includes a hole area laminating portion 211a. The hole area laminating portion 211a is configured to support the flexible screen 20 so as to support the lamination of the flexible screen 20 with an under-screen photosensitive hole of the curved cover plate 10. The main body portion 210 is provided with a clearance slot 213. An opening of the clearance slot 213 is provided at the support back surface 212 and extends toward the planar support surface 211, and the clearance slot 213 at least partially overlaps the hole area laminating portion 211a in the first direction Z.

In these embodiments, when the display device includes an under-screen photosensitive element, the curved cover plate 10 is generally provided with an under-screen photosensitive hole corresponding to the under-screen photosensitive element. The under-screen photosensitive hole is generally a through hole. During the lamination of the curved cover plate 10 with the flexible screen 20, when the force provided by the flexible support table 200 is too large, there may be a risk of film layer breakage in the region of the under-screen photosensitive hole. In the embodiments of the present application, by providing the clearance slot 213 on the main body portion 210, the clearance slot 213 at least partially overlaps the hole area laminating portion 211a in the first direction Z so that the bending deformation capability of the region where the hole area laminating portion 211a is located is increased, to reduce the force provided by the hole area laminating portion 211a to the under-screen photosensitive hole portion, thereby alleviating the risk of film layer breakage in the region of the under-screen photosensitive hole.

In one embodiment, an orthographic projection of the hole area laminating portion 211a in the first direction Z is located within an orthographic projection of the clearance slot 213 in the first direction Z, to better alleviate the risk of film layer breakage in the region of the under-screen photosensitive hole.

In one embodiment, a distance between an edge of the orthographic projection of the hole area laminating portion 211a in the first direction Z and an edge of the orthographic projection of the clearance slot 213 in the first direction Z is greater than or equal to 1 mm, to alleviate the risk of film layer breakage in the region of the under-screen photosensitive hole and its peripheral side.

In one embodiment, the clearance slot 213 is a blind slot, so that the flatness of the planar support surface 211 can be improved.

In one embodiment, the clearance slot 213 has a depth greater than or equal to 1.5 mm to alleviate the risk of film layer breakage in the region of the photosensitive hole due to insufficient depth of the clearance slot 213.

Referring to FIGS. 1 and 16 together, FIG. 16 is a structural schematic view of a base 100 of a support component according to an embodiment of the present application.

In some embodiments, as shown in FIGS. 1 and 16, the base 100 includes a first bearing surface 110 configured to support the main body portion 210 and a second bearing surface 120 configured to support the arc-shaped portion 220. The second bearing surface 120 is in the form of a step, and a distance between the second bearing surface 120 and the first bearing surface 110 in the first direction Z gradually increases in a direction away from the first bearing surface 110.

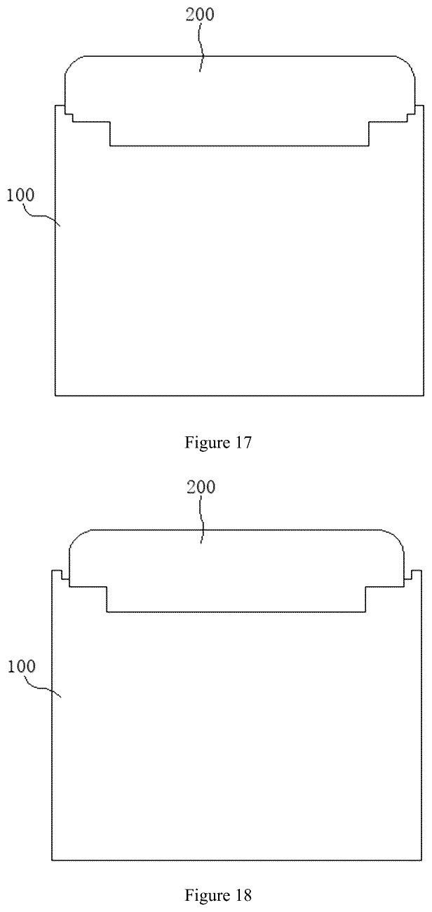

In these embodiments, the second bearing surface 120 is in the form of a step, the second bearing surface 120 includes a plurality of step surfaces, and the distances between the step surfaces and the first bearing surface 110 in the first direction Z gradually increase in the direction away from the first bearing surface 110, so that as shown in FIGS. 17 and 18, the base 100 can be configured to adapt to flexible support tables 200 of different sizes. Moreover, when the recessed portion 230 includes a first step surface 231 and a second step surface 232, the shape of the first bearing surface 110 is more adapted to the shape of the recessed portion 230, and better support can be provided.

In one embodiment, as shown in FIGS. 1 and 16, when the recessed portion 230 includes a first step surface 231 and a second step surface 232, the second bearing surface 120 is adapted to the shape of the recessed portion 230 and includes a first sub-surface 121 and a second sub-surface 122. The first sub-surface 121 is configured to be coupled to the first step surface 231 and the second sub-surface 122 is configured to be coupled to the second step surface 232. In one embodiment, when the second step surface 232 is located on a side of the first step surface 231 away from the main body portion 210 and the second sub-surface 122 is located on a side of the first sub-surface 121 away from the first bearing surface 110, the width of the second sub-surface 122 may be greater than the width of the second step surface 232, to facilitate the mutual alignment of the flexible support table 200 and the base 100. In one embodiment, the second bearing surface 120 may further include a third sub-surface on a side of the second sub-surface 122 facing away from the first sub-surface 121 to adapt to the flexible support tables 200 of different sizes and specifications, thereby improving the adaptability of the base 100.

In some embodiments, the thickness of the main body portion 210 is greater than or equal to the thickness of the arc-shaped portion 220. For example, the main body portion 210 protrudes toward a bottom surface of the base 100 relative to the abutting surface 222, the elastic deformation capability of the main body portion 210 can be increased.

When the main body portion 210 protrudes toward the bottom surface of the base 100 relative to the abutting surface 222, the first bearing surface 110 is recessed relative to the second bearing surface 120 in a direction away from the flexible support table 200, so that the shape of the base 100 is more adapted to the shape of the flexible support table 200.

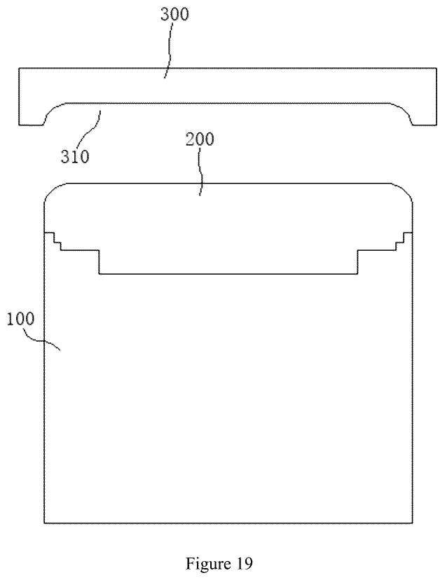

Referring to FIG. 19, FIG. 19 is a structural schematic view of a lamination device according to an embodiment of the present application.

As shown in FIG. 19, in a second aspect, the embodiments of the present application further provide a lamination device for laminating a curved cover plate 10 with a flexible screen 20. The lamination device includes a support component according to any of the above embodiments of the first aspect, and a pressing table 300. The pressing table 300 is arranged on one side of the support component, and the pressing table 300 has a receiving recess 310 for receiving the curved cover plate 10. An opening of the receiving recess 310 faces the support component. Since the lamination device according to the embodiments of the present application includes the support component as described above, the lamination device of the embodiments of the present application has the beneficial effects of the support component as described above, which will not be repeated herein.

1. A support component for laminating a curved cover plate with a flexible screen, the support component comprising:
a base; and
a flexible support table arranged on one side of the base in a first direction and configured to support the flexible screen, the flexible support table comprising a main body portion and an arc-shaped portion arranged on at least one side of the main body portion, wherein the arc-shaped portion comprises an arc-shaped support surface configured to support the flexible screen, and an abutting surface facing the base, the abutting surface being provided with a recessed portion.

2. The support component according to claim 1, wherein the recessed portion comprises a first step surface and a second step surface arranged in a direction perpendicular to the first direction and away from the main body portion and located on a side of the abutting surface facing the arc-shaped support surface, and a distance between the first step surface and the abutting surface is smaller than a distance between the second step surface and the abutting surface in the first direction.

3. The support component according to claim 2, wherein the first step surface is located on a side of the second step surface close to the main body portion in the direction perpendicular to the first direction.

4. The support component according to claim 3, wherein the first step surface and the second step surface are both laminated with the base, and a curvature of at least part of the arc-shaped support surface that overlaps the first step surface is greater than part of the arc-shaped support surface that overlaps the second step surface in the first direction.

5. The support component according to claim 3, wherein the second step surface is connected to an edge of the arc-shaped support surface facing away from the main body portion.

6. The support component according to claim 2, wherein the arc-shaped portion comprises a first arc-shaped portion located on at least one side of the main body portion in a second direction, a second arc-shaped portion located on at least one side of the main body portion in a third direction, and a bent portion connecting the first arc-shaped portion and the second arc-shaped portion, the bent portion being provided with the first step surface and the second step surface.

7. The support component according to claim 1, wherein the recessed portion comprises a groove having an opening provided in the abutting surface.

8. The support component according to claim 7, wherein the groove is spaced apart from an edge of the arc-shaped portion facing away from the main body portion; and,
the groove has a depth greater than or equal to 1.5 mm.

9. The support component according to claim 7, wherein the base further comprises a protrusion located at the groove.

10. The support component according to claim 7, wherein the arc-shaped portion comprises a first arc-shaped portion located on at least one side of the main body portion in a second direction, and the groove comprises a first groove provided at the first arc-shaped portion.

11. The support component according to claim 10, wherein the first groove extends in the form of a strip in a third direction.

12. The support component according to claim 7, wherein the arc-shaped portion further comprises a second arc-shaped portion located on at least one side of the main body portion in a third direction, and the groove comprises a second groove provided at the second arc-shaped portion;
and the second groove extends in the form of a strip in a second direction.

13. The support component according to claim 7, wherein the arc-shaped support surface comprises a first support surface and a second support surface arranged side by side in a direction away from the main body portion, a curvature of the first support surface being greater than the second support surface, and the groove and the first support surface are arranged to at least partially overlap each other in the first direction.

14. The support component according to claim 13, wherein a projection of the first support surface is located within an orthographic projection of the groove in the first direction;
and an extension width of the groove is greater than the first support surface.

15. The support component according to claim 1, wherein the base comprises a first bearing surface configured to support the main body portion and a second bearing surface configured to support the arc-shaped portion, the second bearing surface being in the form of a step, and a distance between the second bearing surface and the first bearing surface in the first direction gradually increasing in a direction away from the first bearing surface.

16. The support component according to claim 1, wherein the main body portion comprises a planar support surface configured to support the flexible screen and a support back surface facing away from the planar support surface, the planar support surface comprising a hole area laminating portion, the hole area laminating portion being configured to support the flexible screen such that the flexible screen is laminated with an under-screen photosensitive hole of the curved cover plate, and a clearance slot being provided on a side of the main body portion facing the base, and orthographic projections of the clearance slot and the hole area laminating portion in the first direction at least partially overlap each other.

17. The support component according to claim 16, wherein the orthographic projection of the hole area laminating portion in the first direction is located within the orthographic projection of the clearance slot in the first direction.

18. The support component according to claim 17, wherein a distance between an edge of the orthographic projection of the hole area laminating portion in the first direction and an edge of the orthographic projection of the clearance slot in the first direction is greater than or equal to 1 mm.

19. The support component according to claim 17, wherein the clearance slot is a blind slot;
and a depth of the clearance slot is greater than or equal to 1.5 mm.

20. A lamination device for laminating a curved cover plate with a flexible screen, the lamination device comprising:
a support component of claim 1, and
a pressing table arranged on one side of the support component, the pressing table comprising a receiving recess for receiving the curved cover plate, and an opening of the receiving recess facing the support component.
